(19) United States
(12) Patent Application Publication
(10) Pub. No.: US 2024/0330709 A1
(43) Pub. Date: Oct. 3, 2024

(54) SHADOW SATISFIABILITY MODULO THEORIES SOLVER SYSTEMS

(71) Applicant: Amazon Technologies, Inc., Seattle, WA (US)

(72) Inventors: Alexandre DAVID, Seattle, WA (US); Jeremiah M. DUNHAM, Arlington, VA (US); Amit GOEL, Portland, OR (US); Dejan JOVANOVIC, Brooklyn, NY (US); Rami Gokhan KICI, Cupertino, CA (US)

(73) Assignee: Amazon Technologies, Inc., Seattle, WA (US)

(21) Appl. No.: 18/193,546

(22) Filed: Mar. 30, 2023

(51) Int. Cl. G06N 5/01; G06N 5/045

(52) U.S. Cl. CPC G06N 5/013; G06N 5/045

(57) ABSTRACT

Techniques are described for executing satisfiability modulo theories (SMT) solvers in a “shadow” system configuration where input queries are provided to a primary SMT solver system and additionally to one or more secondary SMT solver systems. SMT solver systems can be used by cloud providers and in other computing environments to analyze the implications of configured user account policies defining permissions with respect to users' computing resources and associated actions within a computing environment, to help ensure the security of computing resources and user data, etc. The results generated by a primary SMT solver system can be provided to one or more secondary SMT solver systems, where each of the secondary SMT systems can comprise different system components or different versions of system components, to assess the correctness of the primary SMT solver system, to compare performance metrics, among other possible types of analyses.

### BACKGROUND

Cloud provider networks enable users to use a variety of computing-related resources such as compute resources, storage resources, networking resources, and the like. When a user or application interacts with a cloud provider network (e.g., using a web-based console, an application programming interface (API), or a command line interface (CLI) provided by the cloud provider network), the user or application typically is required to specify security credentials to indicate who the user or application is and whether the user or application has permission to access the requested resources. A cloud provider network in turn uses the security credentials to authenticate and authorize the user or application to perform various actions. Access to resources and actions within a cloud provider network may be further managed by policies. A policy is a data object that, when associated with a user or resource, defines its permissions. For example, resource-based policies can be attached to a storage resource, compute instance, encryption keys, etc., and can specify who has access to the resource and what actions those identities can perform on the resource.

### BRIEF DESCRIPTION OF DRAWINGS

Various examples in accordance with the present disclosure will be described with reference to the drawings, in which:

FIG. 1 is a diagram illustrating a computing environment including an automated reasoning service of a cloud provider network comprising a primary satisfiability modulo theories (SMT) solver system and one or more secondary SMT solver systems according to some examples.

FIG. 2 is a diagram illustrating the generation of a formula expressed in first-order logic corresponding to a policy question involving a policy managed by an identity and access management service of a cloud provider network according to some examples.

FIG. 3 illustrates additional details of different types of experimental SMT solver systems that can be used to assess a primary SMT solver system according to some examples.

FIG. 4 illustrates varying sampling rates that experimental SMT solver systems can use according to some examples.

FIG. 5 is a flow diagram illustrating operations of a method for executing satisfiability modulo theories (SMT) solvers in a “shadow” system configuration where input queries are provided to a primary SMT solver system and additionally to one or more secondary SMT solver systems used to assess the accuracy and performance of the primary SMT solver system according to some examples.

FIG. 6 illustrates an example provider network environment according to some examples.

FIG. 7 is a block diagram of an example provider network that provides a storage service and a hardware virtualization service to customers according to some examples.

FIG. 8 is a block diagram illustrating an example computer system that can be used in some examples.

### DETAILED DESCRIPTION

The present disclosure relates to methods, apparatus, systems, and non-transitory computer-readable storage media for executing satisfiability modulo theories (SMT) solvers in a “shadow” system configuration where input queries are provided to a primary SMT solver system and additionally to one or more secondary SMT solver systems used to assess the accuracy and performance of the primary SMT solver system. Among other uses, SMT solver systems can be used by cloud providers and in other computing environments to analyze the implications of configured user account policies defining permissions with respect to users' computing resources and associated actions within a computing environment, to help ensure the security of computing resources and user data, and to help develop and verify software and hardware products. As used herein, an SMT solver system can include a modeler (e.g., a software component used to translate questions provided to the system into corresponding SMT formulas), one or more SMT solvers used to determine whether input SMT formulas are satisfiable, and other related components. According to examples described herein, the results generated by a primary SMT solver system can be provided to one or more secondary SMT solver systems, where each of the secondary SMT systems can comprise different system components or different versions of system components, to assess the correctness of the primary SMT solver system, to compare performance metrics, among other possible types of analyses.

SMT solvers are software-based applications that attempt to determine if mathematical formulas are satisfiable. As indicated, the mathematical formulas analyzed by SMT solvers can be derived from questions about the configuration of users' computing resources in various types of computing environments, about policies defining permissions affecting computing resources and other user data, about the state of software or computer systems, and the like. Several different types of SMT solvers exist today, and new solvers are constantly under development, where each solver generally uses a unique set of heuristics to solve problems provided to it as input. As a result of the variance in heuristics and other techniques used by different solvers, the time required to solve a given formula can vary significantly among different solvers.

For distributed systems that use SMT solvers to obtain optimal aggregate performance across a wide range of input formulas, many systems use “portfolios” of solvers that process input formulas in parallel. In some examples, a portfolio of solvers can operate in a “race” configuration, where a result from a first solver to provide an answer is used and the other solvers are terminated. This arrangement typically works well in terms of performance since a most efficient solver is used for each individual query. However, SMT solvers are subject to bugs and other imperfections that can cause solvers to produce incorrect answers for certain inputs. Furthermore, newer versions of the same SMT solver can be slower than earlier versions, which may also be undesirable. Thus, it is desirable to be able to verify the correctness of solvers and to compare the performance of different solvers across a wide range of input queries.

To address these challenges, among others, a system is described in which “shadow” SMT solver systems can be deployed alongside a primary, or production, SMT solver system, where the shadow SMT solver systems can be used to run different types of experiments on input queries processed by the primary SMT solver system. For example, an automated reasoning service of a cloud provider network can receive a request identifying: a policy associated with one or more computing resources, and a property expressing a desired condition of the policy. The service can then invoke a primary SMT solver system based on the policy and the property, where the first SMT solver system: generates a formula based on the policy and the property, and provides the formula to a portfolio of SMT solvers to obtain first results data indicating whether the formula is satisfiable or unsatisfiable. The automated reasoning service can then cause any number of secondary SMT solver systems to be invoked based on the policy, the property, and the first result data. These secondary SMT solver systems can obtain results from every solver of the portfolio of solvers for comparison to the output from the primary SMT solver system, can include different portfolios of solvers, can include different versions of other system components such as a modeler, etc., all of which can be used for comparison of the accuracy and performance of the primary SMT solver systems. The ability to readily assess the accuracy and performance of SMT solver systems can help improve the security and operation of users computing environments by ensuring that accurate and efficient assessments of their policies and other system components are provided, among other benefits.

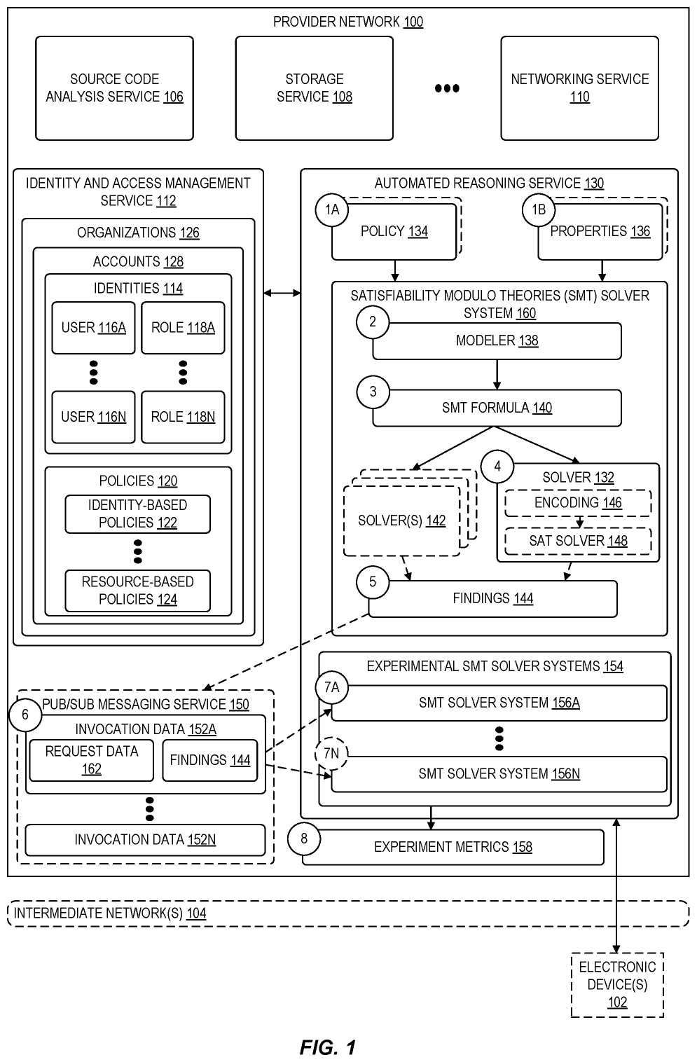

FIG. 1 is a diagram illustrating a computing environment including an automated reasoning service of a cloud provider network comprising a primary satisfiability modulo theories (SMT) solver system and one or more secondary SMT solver systems according to some examples. A provider network 100 (or, “cloud” provider network) provides users with the ability to use one or more of a variety of types of computing-related resources such as compute resources (e.g., executing virtual machine (VM) instances and/or containers, executing batch jobs, executing code without provisioning servers), data/storage resources (e.g., object storage, block-level storage, data archival storage, databases and database tables, etc.), network-related resources (e.g., configuring virtual networks including groups of compute resources, content delivery networks (CDNs), Domain Name Service (DNS)), application resources (e.g., databases, application build/deployment services), access policies or roles, identity policies or roles, machine images, routers and other data processing resources, etc. These and other computing resources can be provided as services, such as a hardware virtualization service that can execute compute instances, a storage service that can store data objects, etc. The users (or “customers”) of provider networks 100 can use one or more user accounts that are associated with a customer account, though these terms can be used somewhat interchangeably depending upon the context of use. Users can use electronic device(s) 102 to interact with a provider network 100 across one or more intermediate networks 104 (e.g., the internet) via one or more interface(s), such as through use of application programming interface (API) calls, via a console implemented as a website or application, etc. An API refers to an interface and/or communication protocol between a client and a server, such that if the client makes a request in a predefined format, the client should receive a response in a specific format or initiate a defined action. In the cloud provider network context, APIs provide a gateway for customers to access cloud infrastructure by allowing customers to obtain data from or cause actions within the cloud provider network, enabling the development of applications that interact with resources and services hosted in the cloud provider network. APIs can also enable different services of the cloud provider network to exchange data with one another. The interface(s) can be part of, or serve as a front-end to, a control plane of the provider network 100 that includes “backend” services supporting and enabling the services that can be more directly offered to customers.

For example, a cloud provider network (or just “cloud”) typically refers to a large pool of accessible virtualized computing resources (such as compute, storage, and networking resources, applications, and services). A cloud can provide convenient, on-demand network access to a shared pool of configurable computing resources that can be programmatically provisioned and released in response to customer commands. These resources can be dynamically provisioned and reconfigured to adjust to variable load. Cloud computing can thus be considered as both the applications delivered as services over a publicly accessible network (e.g., the Internet, a cellular communication network) and the hardware and software in cloud provider data centers that provide those services.

A cloud provider network can be formed as a number of regions, where a region is a geographical area in which the cloud provider clusters data centers. Each region includes multiple (e.g., two or more) availability zones (AZs) connected to one another via a private high-speed network, for example a fiber communication connection. An AZ (also known as a “zone”) provides an isolated failure domain including one or more data center facilities with separate power, separate networking, and separate cooling from those in another AZ. A data center refers to a physical building or enclosure that houses and provides power and cooling to servers of the cloud provider network. Preferably, AZs within a region are positioned far enough away from one another so that a natural disaster (or other failure-inducing event) should not affect or take more than one AZ offline at the same time.

Users can connect to an AZ of the cloud provider network via a publicly accessible network (e.g., the Internet, a cellular communication network), e.g., by way of a transit center (TC). TCs are the primary backbone locations linking users to the cloud provider network and can be collocated at other network provider facilities (e.g., Internet service providers (ISPs), telecommunications providers) and securely connected (e.g., via a VPN or direct connection) to the AZs. Each region can operate two or more TCs for redundancy. Regions are connected to a global network which includes private networking infrastructure (e.g., fiber connections controlled by the cloud provider) connecting each region to at least one other region. The cloud provider network can deliver content from points of presence (or “POPs”) outside of, but networked with, these regions by way of edge locations and regional edge cache servers. This compartmentalization and geographic distribution of computing hardware enables the cloud provider network to provide low-latency resource access to users on a global scale with a high degree of fault tolerance and stability.

Generally, the traffic and operations of a provider network can broadly be subdivided into two categories: control plane operations carried over a logical control plane and data plane operations carried over a logical data plane. While the data plane represents the movement of user data through the distributed computing system, the control plane represents the movement of control signals through the distributed computing system. The control plane generally includes one or more control plane components distributed across and implemented by one or more control servers. Control plane traffic generally includes administrative operations, such as system configuration and management (e.g., resource placement, hardware capacity management, diagnostic monitoring, system state information). The data plane includes user resources that are implemented on the provider network (e.g., computing instances, containers, block storage volumes, databases, file storage). Data plane traffic generally includes non-administrative operations, such as transferring user data to and from the user resources. The control plane components are typically implemented on a separate set of servers from the data plane servers, and control plane traffic and data plane traffic can be sent over separate/distinct networks.

To provide these and other computing resource services, provider networks 100 often rely upon virtualization techniques. For example, virtualization technologies can provide users the ability to control or use compute resources (e.g., a “compute instance,” such as a VM using a guest operating system (O/S) that operates using a hypervisor that might or might not further operate on top of an underlying host O/S, a container that might or might not operate in a VM, a compute instance that can execute on “bare metal” hardware without an underlying hypervisor), where one or multiple compute resources can be implemented using a single electronic device. Thus, a user can directly use a compute resource (e.g., provided by a hardware virtualization service) hosted by the provider network to perform a variety of computing tasks. Additionally, or alternatively, a user can indirectly use a compute resource by submitting code to be executed by the provider network (e.g., via an on-demand code execution service), which in turn uses one or more compute resources to execute the code-typically without the user having any control of or knowledge of the underlying compute instance(s) involved.

As described herein, one type of service that a provider network may provide may be referred to as a “managed compute service” that executes code or provides computing resources for its users in a managed configuration. Examples of managed compute services include, for example, an on-demand code execution service, a hardware virtualization service, a container service, or the like.

An on-demand code execution service (referred to in various examples as a function compute service, functions service, cloud functions service, functions as a service, or serverless computing service) can enable users of the provider network 100 to execute their code on cloud resources without having to select or manage the underlying hardware resources used to execute the code. For example, a user can use an on-demand code execution service by uploading their code and use one or more APIs to request that the service identify, provision, and manage any resources required to run the code. Thus, in various examples, a “serverless” function can include code provided by a user or other entity-such as the provider network itself—that can be executed on demand. Serverless functions can be maintained within the provider network by an on-demand code execution service and can be associated with a particular user or account or can be generally accessible to multiple users/accounts. A serverless function can be associated with a Uniform Resource Locator (URL), Uniform Resource Identifier (URI), or other reference, which can be used to invoke the serverless function. A serverless function can be executed by a compute resource, such as a virtual machine, container, etc., when triggered or invoked. In some examples, a serverless function can be invoked through an application programming interface (API) call or a specially formatted HyperText Transport Protocol (HTTP) request message. Accordingly, users can define serverless functions that can be executed on demand, without requiring the user to maintain dedicated infrastructure to execute the serverless function. Instead, the serverless functions can be executed on demand using resources maintained by the provider network 100. In some examples, these resources can be maintained in a “ready” state (e.g., having a pre-initialized runtime environment configured to execute the serverless functions), allowing the serverless functions to be executed in near real-time.

A hardware virtualization service (referred to in various implementations as an elastic compute service, a virtual machines service, a computing cloud service, a compute engine, or a cloud compute service) can enable users of the provider network 100 to provision and manage compute resources such as virtual machine instances. Virtual machine technology can use one physical server to run the equivalent of many servers (each of which is called a virtual machine), for example using a hypervisor, which can run at least on an offload card of the server (e.g., a card connected via PCI or PCIe to the physical CPUs) and other components of the virtualization host can be used for some virtualization management components. Such an offload card of the host can include one or more CPUs that are not available to user instances, but rather are dedicated to instance management tasks such as virtual machine management (e.g., a hypervisor), input/output virtualization to network-attached storage volumes, local migration management tasks, instance health monitoring, and the like). Virtual machines are commonly referred to as compute instances or simply “instances.” As used herein, provisioning a virtual compute instance generally includes reserving resources (e.g., computational and memory resources) of an underlying physical compute instance for the client (e.g., from a pool of available physical compute instances and other resources), installing or launching required software (e.g., an operating system), and making the virtual compute instance available to the client for performing tasks specified by the client.

Another type of managed compute service can be a container service, such as a container orchestration and management service (referred to in various implementations as a container service, cloud container service, container engine, or container cloud service) that allows users of the cloud provider network to instantiate and manage containers. In some examples the container service can be a Kubernetes-based container orchestration and management service (referred to in various implementations as a container service for Kubernetes, Azure Kubernetes service, IBM cloud Kubernetes service, Kubernetes engine, or container engine for Kubernetes). A container, as referred to herein, packages up code and all its dependencies so an application (also referred to as a task, pod, or cluster in various container services) can run quickly and reliably from one computing environment to another. A container image is a standalone, executable package of software that includes everything needed to run an application process: code, runtime, system tools, system libraries and settings. Container images become containers at runtime. Containers are thus an abstraction of the application layer (meaning that each container simulates a different software application process). Though each container runs isolated processes, multiple containers can share a common operating system, for example by being launched within the same virtual machine. In contrast, virtual machines are an abstraction of the hardware layer (meaning that each virtual machine simulates a physical machine that can run software). While multiple virtual machines can run on one physical machine, each virtual machine typically has its own copy of an operating system, as well as the applications and their related files, libraries, and dependencies. Some containers can be run on instances that are running a container agent, and some containers can be run on bare-metal servers, or on an offload card of a server.

A virtual private cloud (VPC) (also referred to as a virtual network (VNet), virtual private network, or virtual cloud network, in various implementations) is a custom-defined, virtual network within another network, such as a cloud provider network. A VPC can be defined by at least its address space, internal structure (e.g., the computing resources that comprise the VPC, security groups), and transit paths, and is logically isolated from other virtual networks in the cloud. A VPC can span all of the availability zones in a particular region.

A VPC can provide the foundational network layer for a cloud service, for example a compute cloud or an edge cloud, or for a customer application or workload that runs on the cloud. A VPC can be dedicated to a particular customer account (or set of related customer accounts, such as different customer accounts belonging to the same business organization). Customers can launch resources, such as compute instances, into their VPC(s). When creating a VPC, a customer can specify a range of IP addresses for the VPC in the form of a Classless Inter-Domain Routing (CIDR) block. After creating a VPC, a customer can add one or more subnets in each availability zone or edge location associated with its region.

In some examples, an identity and access management service 112 is a service that enables users to securely control access to cloud provider network resources (e.g., computing resources associated with various provider network services, such as storage objects associated with a storage service 108, databases associated with a database service, compute instances associated with a hardware virtualization service, and the like). The identity and access management service 112 is broadly used to control who is permitted to authenticate (e.g., sign in) with the cloud provider network 100 and who is authorized (e.g., has permissions) to use resources provided by the cloud provider network 100. In general, a resource is a concept used to capture the domain of items that can be created, read, modified, or deleted by customers in a cloud provider network 100. Examples of resources also include identities (e.g., identities 114, including example users 116A, . . . , 116N and roles 118A, . . . , 118N) and policies 120 (e.g., including identity-based policies 122, resource-based policies 124, among other possible types of policies). FIG. 1 further illustrates the concept of an organization 126, which can include any number of associated accounts 128, and which can further include any number of users and roles.

When a person initially creates an account with the cloud provider network 100, the person may begin with a single sign-in identity that has complete access to all cloud provider network services and resources associated with the account (e.g., a root user of identities 114). For example, the root user identity may be accessed by signing in with a username (e.g., an email address) and a password used to create the account. Cloud provider networks 100 often advise users not to use a root user for most tasks and instead to create additional user accounts with defined permissions. A user can grant different permissions to different user accounts for different resources. For example, one user account might be configured to allow some users complete access to a hardware virtualization service, a storage service 108, and other cloud provider network 100 resources. For other users, a user account might allow read-only access to some storage buckets, or permission to administer some instances, etc.

In some examples, a principal represents a person or application that can make a request for an action or operation on a resource of the cloud provider network 100 via one or more identities, although sometimes the term principal can be used interchangeably with an identity. The set of identities 114 associated with an account 128 can include any number of users and roles. A cloud provider network request occurs when a principal uses an identity (e.g., a user or a role) to send a request for an action or operation on a resource. A request can include some or all of the following information: the action or operations that the principal wants to perform, the resource object upon which the actions or operations are performed, the person or application that used an identity (e.g., a user or role) to send the request, environment data (e.g., information about the IP address, user agent, SSL enabled status, time of day, etc.), and resource data (e.g., data related to the resource that is being requested, such as a resource identifier, or a tag name). In some examples, the identity and access management service 112 gathers the information contained in a request into a request context, which is used to evaluate and authorize the request.

For some requests to be completed, an identity and access management service 112 determines whether the requesting principal is authorized (e.g., permitted) to complete the request. During authorization, the identity and access management service 112 uses values included in the request context to check for policies that apply to the request. The identity and access management service 112 uses the identified policies to determine whether to allow or deny the request. In some examples, the policies are stored by the identity and access management service 112 as JavaScript Object Notation (JSON) documents (or using any other data format) and specify the permissions for particular identities. There are several types of policies 120 that can potentially affect whether a request is authorized such as, e.g., identity-based policies 122, trust policies, among other policies. For example, to provide users with permissions to access resources in their own account, identity-based policies can be configured, while resource-based policies can be used for granting cross-account access to resources. In some examples, the identity and access management service 112 checks each policy that applies to the context of a request. If a single permissions policy includes a denied action, the identity and access management service 112 denies the entire request. In some examples, an identity and access management service 112 denies requests by default, such that a request is authorized only if every part of a request is allowed by applicable permissions policies.

Once a request is authenticated and authorized, the identity and access management service 112 approves the actions or operations in the request. Operations are defined by a service and include actions that can be performed on or relative to a resource, such as viewing, creating, editing, and deleting that resource. For example, the identity and access management service 112 may support actions such as CreateUser, DeleteUser, CreateRole, and AssumeRole, among many other possible actions. A hardware virtualization service might support actions such as launching a VM instance, deleting a VM instance, etc. To allow a principal to perform an operation, the action is included in a policy that applies to the principal or the affected resource.

According to examples described herein, a provider network 100 includes an automated reasoning service 130 to enable the analysis of policies and the consequence of policies within a cloud provider network. The automated reasoning service 130 further includes a SMT solver system 160, including a portfolio of solvers including a solver 132 and solver(s) 142, used to improve the service's ability to perform automated reasoning tasks related to policy analysis and other types of problems. As described in more detail herein, the automated reasoning service 130 further manages one or more experimental SMT solver systems 154 (e.g., including an SMT solver system 156A, . . . , SMT solver system 156N) used to check the correctness, performance, or other characteristics of the SMT solver system 160, which may be used to service production traffic in the cloud provider network 100.

As shown in FIG. 1, an automated reasoning service 130 takes as input one or more policies 134 and one or more properties 136 (or rules) (e.g., “no public read/write access should be allowed for storage resources”, “server-side encryption should be enabled for a storage resource”, etc.). For example, the input received by the automated reasoning service 130 can be responsive to a user request to analyze one or more resources and policies or a request can be generated automatically by one or more services of a cloud provider network (e.g., by a source code analysis service 106, storage service 108, networking service 110, etc.). As described in more detail hereinafter, the automated reasoning service 130 broadly obtains, at circles “1A” and “1B,” the one or more policies 134 and properties 136; at circle “2,” the automated reasoning service 130 uses a modeler 138 to model the policy or policies 134 and property or properties 136 as an SMT formula 140 (shown at circle “3”); and at circle “4,” the automated reasoning service 130 provides the SMT formula 140 to a solver 132, or to a portfolio solver comprising multiple solvers including solver(s) 142, to determine the satisfiability of the formula at circle “4.” The automated reasoning service 130 uses the result of the solver 132 (or one of solver(s) 142) to inform a user or other system that the input policy 134 or policies either adheres to the properties 136 or not, illustrated at circle “5” as findings 144. For example, the findings 144 might alert a user that a policy associated with the user permits public write access to a resource, which may be unintended, or the findings 144 might be provided to one or more downstream components that generate alerts, additional analyses, or the like. As shown, a solver 132 broadly can include a process of encoding 146 an input SMT formula 140 into an equisatisfiable propositional formula and using a SAT solver 148 to determine whether the encoded formula is satisfiable, or a solver can broadly use any other processes for determining the satisfiability of an SMT formula 140 depending on the type of input question. In some examples, an SMT solver system 160 uses a portfolio of solvers (e.g., solver 132 and solvers 142) in parallel and uses a response returned from the first solver to generate an answer as part of the resulting findings 144. In this arrangement, the solvers that have not yet returned an answer can be terminated such that the computing resources can be released for subsequent executions.

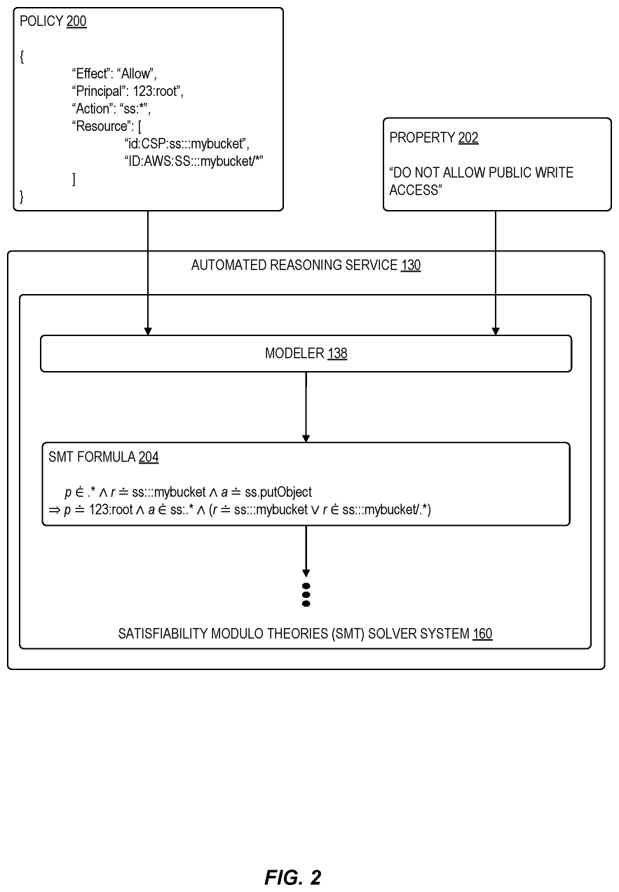

As indicated, part of answering a question related to one or more policies and one or more properties involves using a modeler 138 to translate the one or more policies and properties into a formula that can be analyzed by a SMT solver or portfolio of solvers. FIG. 2 is a diagram illustrating the generation of a formula expressed in first-order logic corresponding to a policy question involving a policy managed by an identity and access management service of a cloud provider network according to some examples. As shown, the input to a modeler 138 can include one or more policies (e.g., a policy 200 including the illustrated policy snippet) and one or more properties or questions (e.g., a property 202 indicating a desired condition of the policy 200). In this example, the property 202 indicates that it is desired for the policy 200 to not allow public write access to any computing resource governed by the policy 200. In general, a question about the desired condition of the policy can include, for example, determining whether public write access is permitted on a computing resource, determining whether unencrypted writes are permitted on a computing resources, determining whether public read access is permitted on a computing resource, or determining whether Secure Socket Layer (SSL) requests are required to access a computing resource, comparing a permissiveness of two policies relative to one another, or the like.

In some examples, the modeler 138 translates the one or more input policies and rules into a SMT formula 204 (or SMT query) involving a theory of strings. The statements can include Boolean combinations (and, or, not), word equations (e.g., x=const., and x=y, where x is a string variable), and regular constraints. In the example of FIG. 2, the formula 204 is a quantifier-free formula expressed in first-order logic.

As indicated, an automated reasoning service 130 can use a solver or a portfolio of solvers to answer questions involving one or more policies and one or more associated properties. Users may further naturally desire to verify the correctness of findings generated by a SMT solver system 160 to identify potential bugs or other misconfigurations associated with the SMT solver system 160, to assess the performance of a SMT solver system compared to other systems comprising different modeler configurations, different solver portfolio compositions, and the like. It is further desirable for such assessments to be performed with minimal impact on the performance and availability of a SMT solver system 160, which may be relied upon by users and other services of a cloud provider network 100. According to examples described herein, techniques for using one or more secondary, or “experimental,” SMT solver systems in parallel with a primary SMT solver system are described.

In FIG. 1, for example, one or more additional SMT solver systems (e.g., experimental SMT solver systems 154 including SMT solver system 156A, . . . , SMT solver system 156N) can be used to re-analyze results data generated by a SMT solver system 160 (e.g., invocation data 152A, . . . , invocation data 152N) or similar results data derived from any other source. As shown, invocation data 152A corresponding to an invocation of a SMT solver system 160 can include, among other possible information, request data 162 and corresponding findings 144. In this example, the invocation data 152A can include for example information about a request identifying one or more policies 134, properties 136, and any other information about the invocation of a SMT solver system 160 resulting in the findings 144. In some examples, the invocation data can include information reflecting a state of the SMT solver system 160 including, e.g., a version of the SMT solver system or components thereof, information about a region of the provider network 100 in which the automated reasoning service 130 was executed, information about resources, tags, or other data accessed by the SMT solver system 160 as part of the invocation, and the like. The state information, for example, can be stored as a hash of various data elements or in any other form. In some examples, the invocation data can optionally include different types of policies as compared to those analyzed by the SMT solver system 160, e.g., to test the performance of the experimental SMT solver system 154 against new or modified types of policies.

In some examples, at circle “6,” the automated reasoning service 130 stores invocation data 152A in a queue provided by a pub/sub messaging service 150 or in any other type of data store. Each of the invocation data records, for example, can be generated based on an invocation of the SMT system 160 by the automated reasoning service 130 and resulting in findings. As indicated above, the invocation of the SMT solver system 160 generally includes generating, by a modeler 138, a first-order logic formula (or SMT formula 140) based on one or more policies 134 and one or more properties 136. The SMT formula 140 is then provided to a first plurality of SMT solvers (e.g., solver 132 and solver(s) 142) to obtain findings 144. The findings 144 can then be stored, along with request data 162 that resulted in the findings 144, at a storage location accessible to one or more experimental SMT solver systems 154. In some examples, at circle “7A”, . . . , circle “7N”, one or more of the experimental SMT solver systems 154 (e.g., a SMT solver system 156A, . . . , SMT solver system 156N) can each independently analyze the same request data as that originally analyzed by the SMT solver system 160 to determine whether the results match. As indicated, these experimental SMT solver systems 154 broadly can be used to verify the accuracy of findings produced by the SMT solver system 160, to assess the performance of the SMT solver system 160, and the like. For example, the experimental SMT solver systems 154 can collectively or independently generate experiment metrics 158 indicating, among other possible information, findings generated by the experimental SMT solver systems, identifiers of state information related to the SMT solver systems generating the findings, an amount of time elapsed for the SMT solver systems to generate the associated findings, and the like. These experiment metrics 158 can be used to identify inconsistent results obtained by experimental SMT solver systems compared to the SMT solver system 160, performance comparisons, and the like.

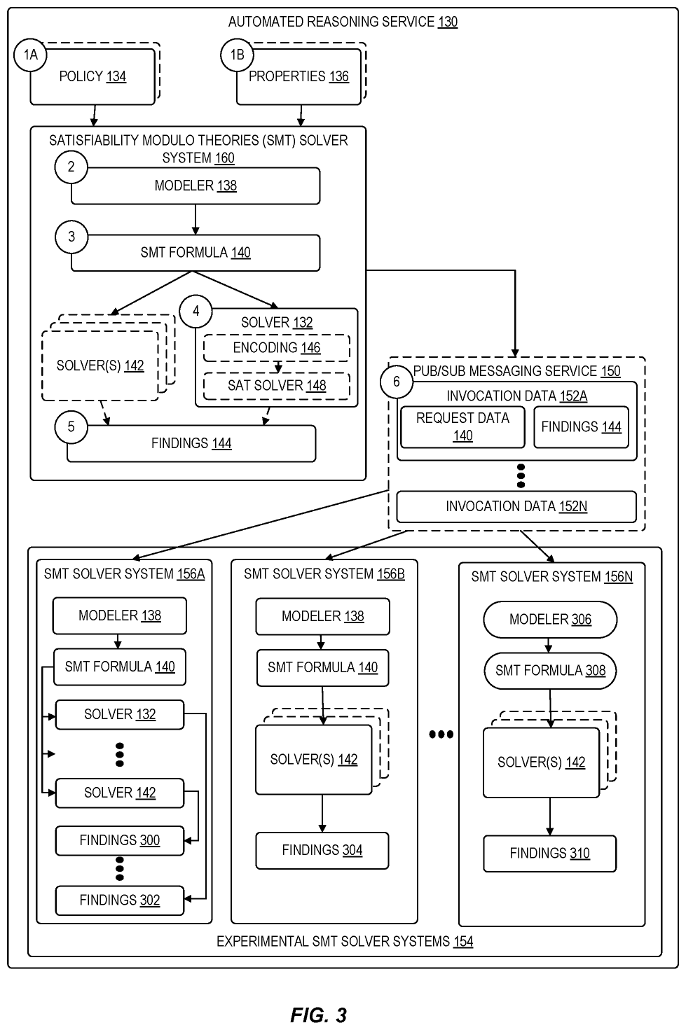

FIG. 3 illustrates additional details of different types of experimental SMT solver systems that can be used to assess a primary SMT solver system according to some examples. Similar to FIG. 1, an automated reasoning service 130 can include an SMT solver system 160 (e.g., used for production traffic) and a collection of one or more experimental SMT solver systems 154. In the example of FIG. 3, several different types of experimental SMT solver systems are shown, including an SMT solver system 156A, SMT solver system 156B, . . . , and SMT solver system 156N.

In general, the experimental SMT solver systems shown in FIG. 3 illustrate different ways in which experimental SMT solver systems can be used to assess a primary SMT solver system (e.g., SMT solver system 160). The SMT solver system 156A, for example, illustrates a configuration in which an SMT solver system 156A executes each of a plurality of different SMT solvers (e.g., possibly a same set of solvers used by the SMT solver system 160) in isolation and obtains a result from each solver (e.g., shown as findings 300, . . . , findings 302). As indicated above, in some examples, a SMT solver system 160 can execute a portfolio of solvers, use the answer obtained from a solver that returns a finding earliest compared to the other solvers, and terminate the other solvers in the portfolio of solvers. The SMT solver system 156A thus can be used to determine whether any of the other solvers, which may take longer to execute than one or more of the other solvers in the portfolio of solvers, return a finding that differs from the finding returned by the solver used by the SMT solver system 160. A discrepancy between a result returned by a solver of the SMT solver system 156A and the SMT solver system 160 may, for example, indicate a bug or other issue with one or both solvers. The results from the SMT solver system 156A can thus be stored as part of experiment metrics 158 and any discrepancies can be used to generate an alert, displayed as part of a metrics dashboard or other interface, or used by any other relevant downstream components. The SMT solver system 156A can further store performance metrics related to an execution time, memory usage, or any other metrics related to execution of the solvers for comparison to the SMT solver system 160 or other solvers.

In some examples, the SMT solver system 156B illustrates another example configuration in which one or more different portfolio of solvers are used as compared to the SMT solver system 160. For example, the portfolio of solvers used in the SMT solver system 156B can include one or more additional solvers compared to the SMT solver system 160, one or more different versions of the solvers used by the SMT solver system 160, one or more fewer solvers compared to the SMT solver system 160, different configuration settings associated with one or more solvers, or any other differences compared to the SMT solver system 160 that may be desired for testing. Like SMT solver system 156A, the SMT solver system 156B can generate and store experiment metrics 158 reflecting information about the results and performance of the SMT solver system 156B for the same invocation data analyzed by the SMT solver system 160 (e.g., shown as findings 304). This information can be displayed in various web-based dashboards, provided to downstream components for further analysis, used to generate alerts, or for any other purposes.

In some examples, the SMT solver system 156N illustrates yet another example configuration in which one or more different versions of the SMT solver system 160 itself are used (e.g., including implementation or configuration changes to the modeler 138, shown as modeler 306 and resulting in possibly a different SMT formula 308, or other components of the SMT solver system 160). For example, the modeler 138 can include any number of flags and other configurations that determine how the modeler 138 translates policies and properties into a corresponding SMT formula 140. The different versions of the SMT solver system 160 used in SMT solver system 156N can be used to test different modeler 138 settings, different implementations of the modeler 138, or to test different settings or versions associated with other components of the SMT solver system 160, resulting in findings 310. Although three different example types of SMT solver system experiments are shown in FIG. 3, in general, any number of different experimental SMT solver systems 154 can be used as desired to test different solver configurations, modeler versions and configurations, or any other SMT solver system arrangements.

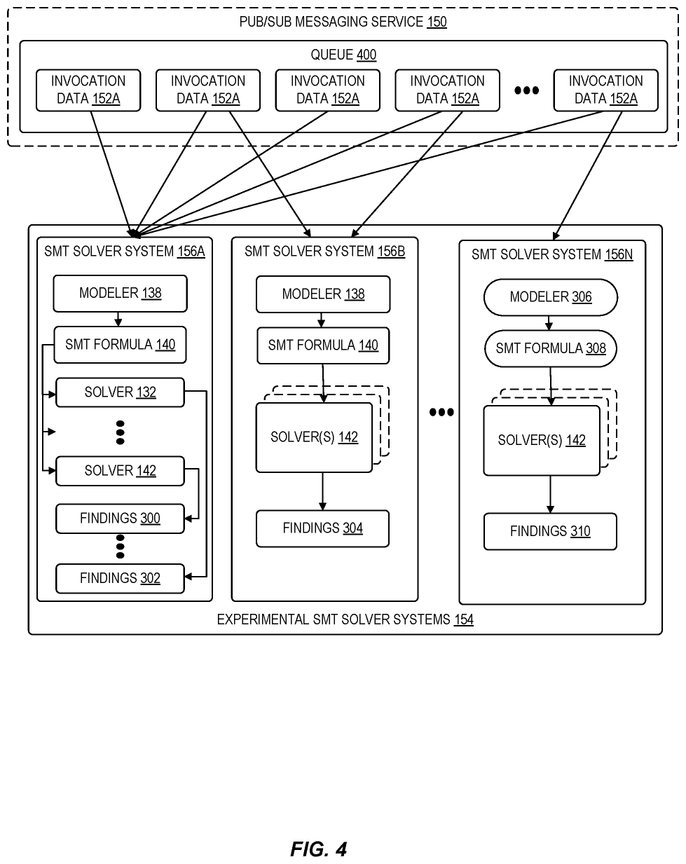

FIG. 4 illustrates varying sampling rates that experimental SMT solver systems 154 can use according to some examples. For example, referring to FIG. 1, a SMT solver system 160 can generate results data for each request processed by the automated reasoning service 130 and cause the results data to be stored using a queue 400 provided by a pub/sub messaging service 150, or using any other storage resource accessible to one or more experimental SMT solver systems 154. Depending on the resource requirements of each of the experimental SMT solver systems 154 and other considerations, each of the experimental SMT solver systems 154 can independently analyze all of the results data generated by a primary SMT solver system 160, or only a sampled portion of the results data. As shown in FIG. 4, for example, a first SMT solver system 156A can analyze all results data generated by the SMT solver system 160, while a second SMT solver system 156N can analyze only a sampled portion of the results data generated by the SMT solver system 160. The use of a pub/sub messaging service 150 or other storage service, for example, enables the experimental SMT solver systems 154 to subscribe to a queue or other storage resource and invoke a SMT solver for only sampled set of results data or for results data matching certain conditions of interest.

Although many of the examples described herein are shown in the context of a cloud provider network, the systems described herein involving a primary SMT solver system and one or more experimental SMT solver systems can also be used in other on-premises computing environments, hybrid on-premises and cloud computing environments, and the like. For example, a primary SMT solver system 160 can be deployed on a server running in a user's on-premises environment and one or more experimental SMT solver systems can further be deployed in a same on-premises environment, in a separate computing environment, in a provider network 100, or other similar arrangement. Furthermore, many of the provided examples involve the use and comparison of SMT solvers. In other examples, an automated reasoning service 130 can use experimental solver systems to verify the accuracy and compare performance metrics of SAT solvers or other types of automated reasoning-related solvers. For example, SAT solvers can be used and tested more directly to analyze questions related to model checking among other problems.

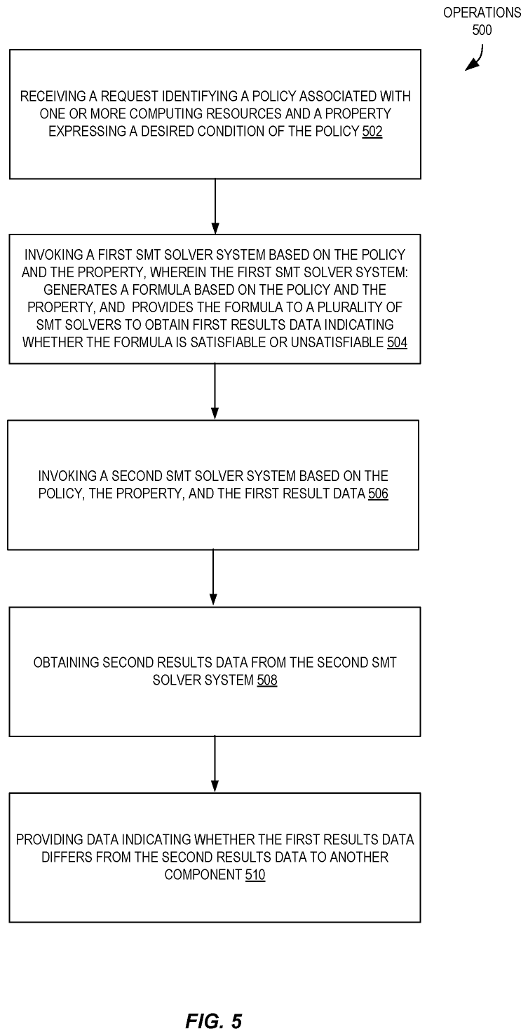

FIG. 5 is a flow diagram illustrating operations 500 of a method for executing satisfiability modulo theories (SMT) solvers in a “shadow” system configuration where input queries are provided to a primary SMT solver system and additionally to one or more secondary SMT solver systems used to assess the accuracy and performance of the primary SMT solver system according to some examples. Some or all of the operations 500 (or other processes described herein, or variations, and/or combinations thereof) are performed under the control of one or more computer systems configured with executable instructions, and are implemented as code (e.g., executable instructions, one or more computer programs, or one or more applications) executing collectively on one or more processors. The code is stored on a computer-readable storage medium, for example, in the form of a computer program comprising instructions executable by one or more processors. The computer-readable storage medium is non-transitory. In some examples, one or more (or all) of the operations 500 are performed by an automated reasoning service of the other figures.

The operations 500 include, at block 502, receiving a request identifying a policy associated with one or more computing resources and a property expressing a desired condition of the policy.

The operations 500 further include, at block 504, invoking a first SMT solver system based on the policy and the property, wherein the first SMT solver system: generates a formula based on the policy and the property, and provides the formula to a plurality of SMT solvers to obtain first results data indicating whether the formula is satisfiable or unsatisfiable.

The operations 500 further include, at block 506, invoking a second SMT solver system based on the policy, the property, and the first result data.

The operations 500 further include, at block 508, obtaining second results data from the second SMT solver system.

The operations 500 further include, at block 510, providing data indicating whether the first results data differs from the second results data to another component.

In some examples, invoking the first SMT solver system further causes the first SMT solver system to: obtain the first results data based on an earliest result received from an SMT solver of the plurality of SMT solvers, and terminate SMT solvers of the plurality of SMT solvers from which the earliest result was not obtained; and wherein the second SMT solver system obtains results from two or more of the plurality of the plurality of SMT solvers, and wherein the second results data includes the results from two or more of the plurality of SMT solvers.

In some examples, the second SMT solver system differs from the first SMT solver system based on at least one of: a different implementation of a modeler used to generate the formula based on the policy and the property, or one or more different configurations of the modeler.

In some examples, the operations further include storing, by the first SMT solver system, the first results data in a storage resource accessible to the first SMT solver system and the second SMT solver system; and obtaining, by the second SMT solver system, the first results data from the storage resource.

In some examples, the operations further include storing, by the first SMT solver system, a plurality of results data including the first results data in a storage resource accessible to the first SMT solver system and the second SMT solver system; and wherein the second SMT solver system is invoked on a sampled subset of the plurality of results data stored in the storage resource.

In some examples, wherein the second SMT solver system includes a second plurality of SMT solvers that is different from the first plurality of SMT solvers, and wherein the second plurality of SMT solvers is different from the first plurality of SMT solvers based on at least one of: the second plurality of SMT solvers includes an additional SMT solver compared to the first plurality of SMT solvers, the second plurality of SMT solvers includes fewer solvers compared to the first plurality of SMT solvers, or the second plurality of SMT solvers includes a different version of a solver in the first plurality of SMT solvers.

In some examples, the operations further include invoking a third SMT solver system based on the policy, the property, and the first result data; obtaining third results data from the third SMT solver system; comparing the third results data to the second results data; and causing display of information indicating a difference between the third results data and the second results data.

In some examples, the operations further include generating an alert indicating the difference between the first results data and the second results data.

In some examples, the operations further include receiving input identifying a plurality of requests, wherein each of the plurality of requests identifies a respective policy and a respective condition; and invoking the second SMT solver system on each request of the plurality of requests.

In some examples, the operations further include storing, by the first SMT solver system, first metrics related a first execution time of the first SMT solver system to obtain the first results data; and storing, by the second SMT solver system, second metrics related to a second execution time of the second SMT solver system to obtain the second results data.

In some examples, the results data includes information identifying a version of the first SMT solver system and state information related to the first SMT solver system during invocation of the first SMT solver system.

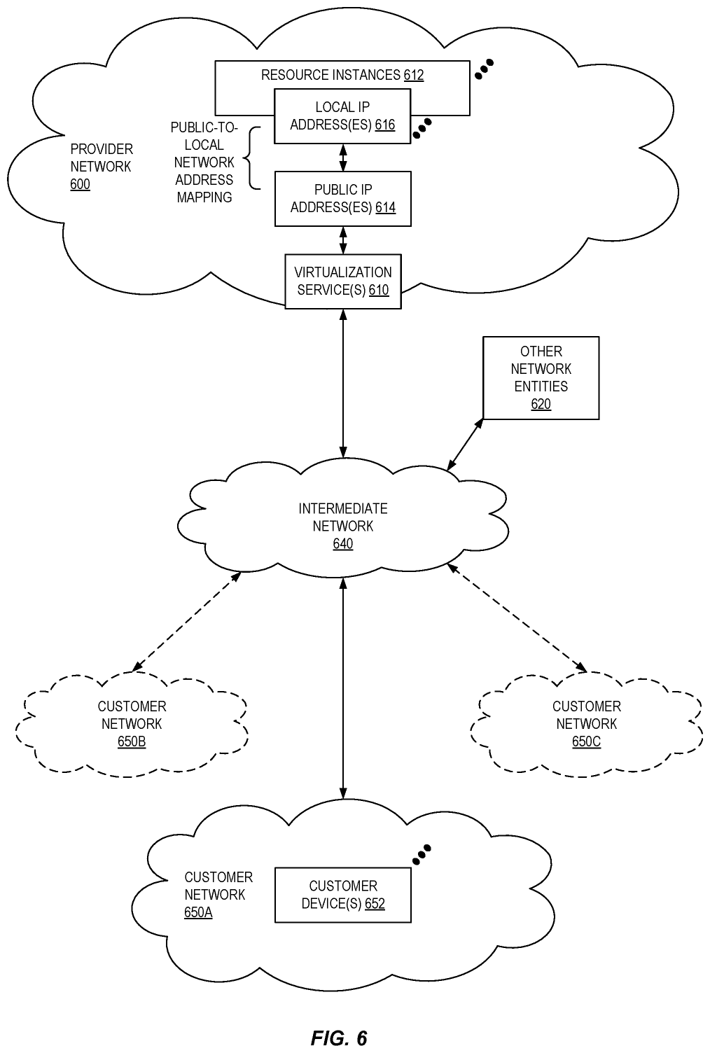

FIG. 6 illustrates an example provider network (or “service provider system”) environment according to some examples. A provider network 600 can provide resource virtualization to customers via one or more virtualization services 610 that allow customers to purchase, rent, or otherwise obtain instances 612 of virtualized resources, including but not limited to computation and storage resources, implemented on devices within the provider network or networks in one or more data centers. Local Internet Protocol (IP) addresses 616 can be associated with the resource instances 612; the local IP addresses are the internal network addresses of the resource instances 612 on the provider network 600. In some examples, the provider network 600 can also provide public IP addresses 614 and/or public IP address ranges (e.g., Internet Protocol version 4 (IPv4) or Internet Protocol version 6 (IPv6) addresses) that customers can obtain from the provider 600.

Conventionally, the provider network 600, via the virtualization services 610, can allow a customer of the service provider (e.g., a customer that operates one or more customer networks 650A-650C (or “client networks”) including one or more customer device(s) 652) to dynamically associate at least some public IP addresses 614 assigned or allocated to the customer with particular resource instances 612 assigned to the customer. The provider network 600 can also allow the customer to remap a public IP address 614, previously mapped to one virtualized computing resource instance 612 allocated to the customer, to another virtualized computing resource instance 612 that is also allocated to the customer. Using the virtualized computing resource instances 612 and public IP addresses 614 provided by the service provider, a customer of the service provider such as the operator of the customer network(s) 650A-650C can, for example, implement customer-specific applications and present the customer's applications on an intermediate network 640, such as the Internet. Other network entities 620 on the intermediate network 640 can then generate traffic to a destination public IP address 614 published by the customer network(s) 650A-650C; the traffic is routed to the service provider data center, and at the data center is routed, via a network substrate, to the local IP address 616 of the virtualized computing resource instance 612 currently mapped to the destination public IP address 614. Similarly, response traffic from the virtualized computing resource instance 612 can be routed via the network substrate back onto the intermediate network 640 to the source entity 620.

Local IP addresses, as used herein, refer to the internal or “private” network addresses, for example, of resource instances in a provider network. Local IP addresses can be within address blocks reserved by Internet Engineering Task Force (IETF) Request for Comments (RFC) 1918 and/or of an address format specified by IETF RFC 4193 and can be mutable within the provider network. Network traffic originating outside the provider network is not directly routed to local IP addresses; instead, the traffic uses public IP addresses that are mapped to the local IP addresses of the resource instances. The provider network can include networking devices or appliances that provide network address translation (NAT) or similar functionality to perform the mapping from public IP addresses to local IP addresses and vice versa.

Public IP addresses are Internet mutable network addresses that are assigned to resource instances, either by the service provider or by the customer. Traffic routed to a public IP address is translated, for example via 1:1 NAT, and forwarded to the respective local IP address of a resource instance.

Some public IP addresses can be assigned by the provider network infrastructure to particular resource instances; these public IP addresses can be referred to as standard public IP addresses, or simply standard IP addresses. In some examples, the mapping of a standard IP address to a local IP address of a resource instance is the default launch configuration for all resource instance types.

At least some public IP addresses can be allocated to or obtained by customers of the provider network 600; a customer can then assign their allocated public IP addresses to particular resource instances allocated to the customer. These public IP addresses can be referred to as customer public IP addresses, or simply customer IP addresses. Instead of being assigned by the provider network 600 to resource instances as in the case of standard IP addresses, customer IP addresses can be assigned to resource instances by the customers, for example via an API provided by the service provider. Unlike standard IP addresses, customer IP addresses are allocated to customer accounts and can be remapped to other resource instances by the respective customers as necessary or desired. A customer IP address is associated with a customer's account, not a particular resource instance, and the customer controls that IP address until the customer chooses to release it. Unlike conventional static IP addresses, customer IP addresses allow the customer to mask resource instance or availability zone failures by remapping the customer's public IP addresses to any resource instance associated with the customer's account. The customer IP addresses, for example, enable a customer to engineer around problems with the customer's resource instances or software by remapping customer IP addresses to replacement resource instances.

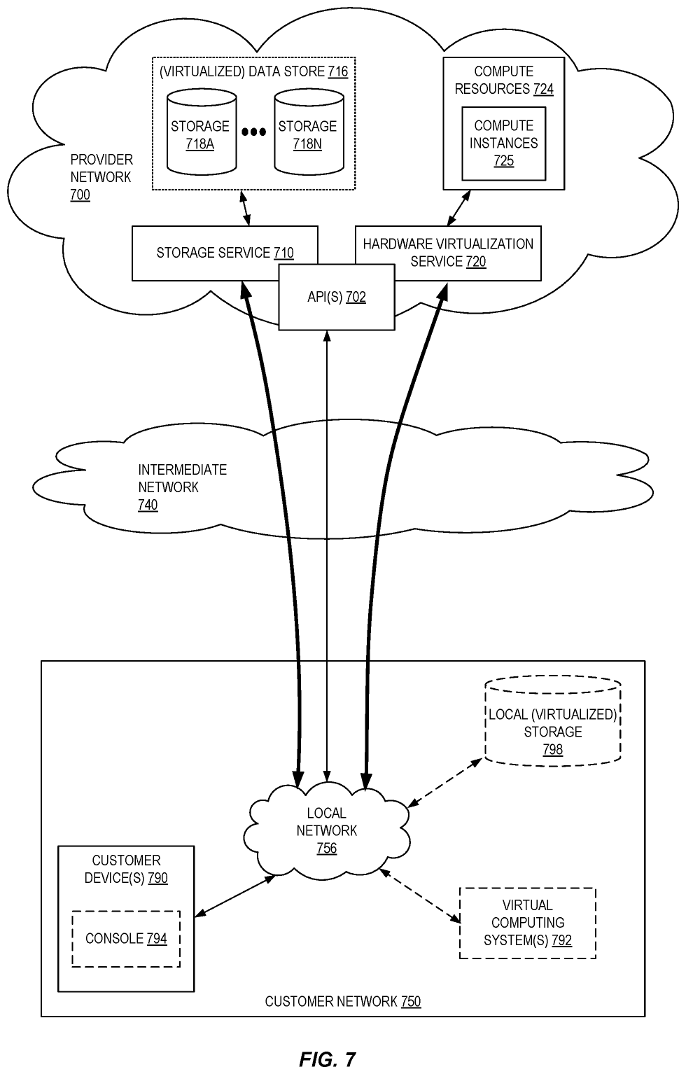

FIG. 7 is a block diagram of an example provider network environment that provides a storage service and a hardware virtualization service to customers, according to some examples. A hardware virtualization service 720 provides multiple compute resources 724 (e.g., compute instances 725, such as VMs) to customers. The compute resources 724 can, for example, be provided as a service to customers of a provider network 700 (e.g., to a customer that implements a customer network 750). Each computation resource 724 can be provided with one or more local IP addresses. The provider network 700 can be configured to route packets from the local IP addresses of the compute resources 724 to public Internet destinations, and from public Internet sources to the local IP addresses of the compute resources 724.

The provider network 700 can provide the customer network 750, for example coupled to an intermediate network 740 via a local network 756, the ability to implement virtual computing systems 792 via the hardware virtualization service 720 coupled to the intermediate network 740 and to the provider network 700. In some examples, the hardware virtualization service 720 can provide one or more APIs 702, for example a web services interface, via which the customer network 750 can access functionality provided by the hardware virtualization service 720, for example via a console 794 (e.g., a web-based application, standalone application, mobile application, etc.) of a customer device 790. In some examples, at the provider network 700, each virtual computing system 792 at the customer network 750 can correspond to a computation resource 724 that is leased, rented, or otherwise provided to the customer network 750.

From an instance of the virtual computing system(s) 792 and/or another customer device 790 (e.g., via console 794), the customer can access the functionality of a storage service 710, for example via the one or more APIs 702, to access data from and store data to storage resources 718A-718N of a virtual data store 716 (e.g., a folder or “bucket,” a virtualized volume, a database, etc.) provided by the provider network 700. In some examples, a virtualized data store gateway (not shown) can be provided at the customer network 750 that can locally cache at least some data, for example frequently accessed or critical data, and that can communicate with the storage service 710 via one or more communications channels to upload new or modified data from a local cache so that the primary store of data (the virtualized data store 716) is maintained. In some examples, a user, via the virtual computing system 792 and/or another customer device 790, can mount and access virtual data store 716 volumes via the storage service 710 acting as a storage virtualization service, and these volumes can appear to the user as local (virtualized) storage 798.

While not shown in FIG. 7, the virtualization service(s) can also be accessed from resource instances within the provider network 700 via the API(s) 702. For example, a customer, appliance service provider, or other entity can access a virtualization service from within a respective virtual network on the provider network 700 via the API(s) 702 to request allocation of one or more resource instances within the virtual network or within another virtual network.

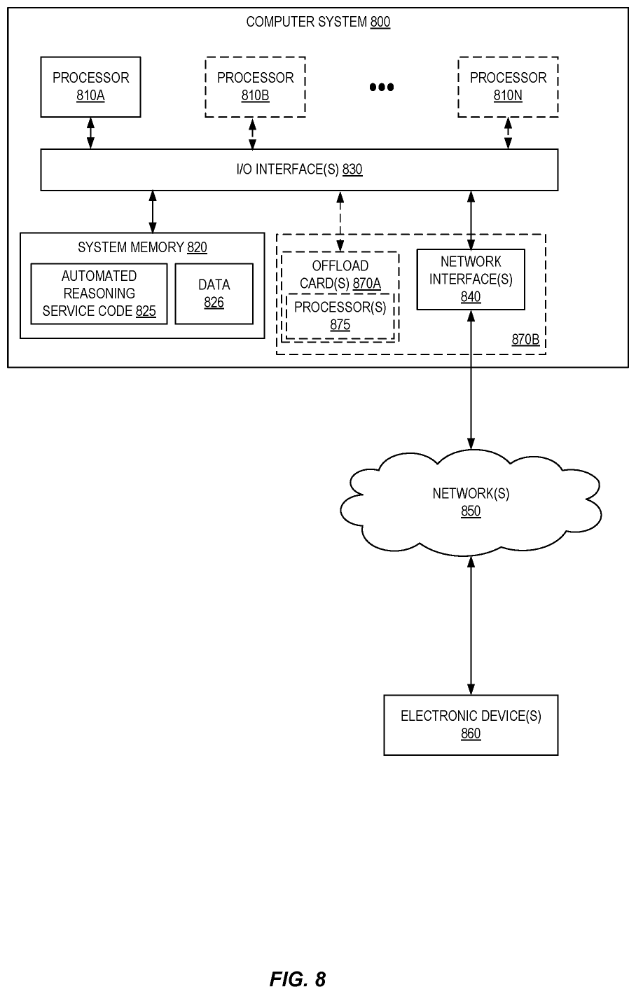

In some examples, a system that implements a portion or all of the techniques described herein can include a general-purpose computer system, such as the computer system 800 (also referred to as a computing device or electronic device) illustrated in FIG. 8, that includes, or is configured to access, one or more computer-accessible media. In the illustrated example, the computer system 800 includes one or more processors 810 coupled to a system memory 820 via an input/output (I/O) interface 830. The computer system 800 further includes a network interface 840 coupled to the I/O interface 830. While FIG. 8 shows the computer system 800 as a single computing device, in various examples the computer system 800 can include one computing device or any number of computing devices configured to work together as a single computer system 800.

In various examples, the computer system 800 can be a uniprocessor system including one processor 810, or a multiprocessor system including several processors 810 (e.g., two, four, eight, or another suitable number). The processor(s) 810 can be any suitable processor(s) capable of executing instructions. For example, in various examples, the processor(s) 810 can be general-purpose or embedded processors implementing any of a variety of instruction set architectures (ISAs), such as the x86, ARM, PowerPC, SPARC, or MIPS ISAs, or any other suitable ISA. In multiprocessor systems, each of the processors 810 can commonly, but not necessarily, implement the same ISA.

The system memory 820 can store instructions and data accessible by the processor(s) 810. In various examples, the system memory 820 can be implemented using any suitable memory technology, such as random-access memory (RAM), static RAM (SRAM), synchronous dynamic RAM (SDRAM), nonvolatile/Flash-type memory, or any other type of memory. In the illustrated example, program instructions and data implementing one or more desired functions, such as those methods, techniques, and data described above, are shown stored within the system memory 820 as automated reasoning service code 825 (e.g., executable to implement, in whole or in part, the automated reasoning service 130) and data 826.

In some examples, the I/O interface 830 can be configured to coordinate I/O traffic between the processor 810, the system memory 820, and any peripheral devices in the device, including the network interface 840 and/or other peripheral interfaces (not shown). In some examples, the I/O interface 830 can perform any necessary protocol, timing, or other data transformations to convert data signals from one component (e.g., the system memory 820) into a format suitable for use by another component (e.g., the processor 810). In some examples, the I/O interface 830 can include support for devices attached through various types of peripheral buses, such as a variant of the Peripheral Component Interconnect (PCI) bus standard or the Universal Serial Bus (USB) standard, for example. In some examples, the function of the I/O interface 830 can be split into two or more separate components, such as a north bridge and a south bridge, for example. Also, in some examples, some or all of the functionality of the I/O interface 830, such as an interface to the system memory 820, can be incorporated directly into the processor 810.

The network interface 840 can be configured to allow data to be exchanged between the computer system 800 and other devices 860 attached to a network or networks 850, such as other computer systems or devices as illustrated in FIG. 1, for example. In various examples, the network interface 840 can support communication via any suitable wired or wireless general data networks, such as types of Ethernet network, for example. Additionally, the network interface 840 can support communication via telecommunications/telephony networks, such as analog voice networks or digital fiber communications networks, via storage area networks (SANs), such as Fibre Channel SANs, and/or via any other suitable type of network and/or protocol.

In some examples, the computer system 800 includes one or more offload cards 870A or 870B (including one or more processors 875, and possibly including the one or more network interfaces 840) that are connected using the I/O interface 830 (e.g., a bus implementing a version of the Peripheral Component Interconnect-Express (PCI-E) standard, or another interconnect such as a QuickPath interconnect (QPI) or UltraPath interconnect (UPI)). For example, in some examples the computer system 800 can act as a host electronic device (e.g., operating as part of a hardware virtualization service) that hosts compute resources such as compute instances, and the one or more offload cards 870A or 870B execute a virtualization manager that can manage compute instances that execute on the host electronic device. As an example, in some examples the offload card(s) 870A or 870B can perform compute instance management operations, such as pausing and/or un-pausing compute instances, launching and/or terminating compute instances, performing memory transfer/copying operations, etc. These management operations can, in some examples, be performed by the offload card(s) 870A or 870B in coordination with a hypervisor (e.g., upon a request from a hypervisor) that is executed by the other processors 810A-810N of the computer system 800. However, in some examples the virtualization manager implemented by the offload card(s) 870A or 870B can accommodate requests from other entities (e.g., from compute instances themselves), and cannot coordinate with (or service) any separate hypervisor.

In some examples, the system memory 820 can be one example of a computer-accessible medium configured to store program instructions and data as described above. However, in other examples, program instructions and/or data can be received, sent, or stored upon different types of computer-accessible media. Generally speaking, a computer-accessible medium can include any non-transitory storage media or memory media such as magnetic or optical media, e.g., disk or DVD/CD coupled to the computer system 800 via the I/O interface 830. A non-transitory computer-accessible storage medium can also include any volatile or non-volatile media such as RAM (e.g., SDRAM, double data rate (DDR) SDRAM, SRAM, etc.), read only memory (ROM), etc., that can be included in some examples of the computer system 800 as the system memory 820 or another type of memory. Further, a computer-accessible medium can include transmission media or signals such as electrical, electromagnetic, or digital signals, conveyed via a communication medium such as a network and/or a wireless link, such as can be implemented via the network interface 840.

Various examples discussed or suggested herein can be implemented in a wide variety of operating environments, which in some cases can include one or more user computers, computing devices, or processing devices which can be used to operate any of a number of applications. User or client devices can include any of a number of general-purpose personal computers, such as desktop or laptop computers running a standard operating system, as well as cellular, wireless, and handheld devices running mobile software and capable of supporting a number of networking and messaging protocols. Such a system also can include a number of workstations running any of a variety of commercially available operating systems and other known applications for purposes such as development and database management. These devices also can include other electronic devices, such as dummy terminals, thin-clients, gaming systems, and/or other devices capable of communicating via a network.

Most examples use at least one network that would be familiar to those skilled in the art for supporting communications using any of a variety of widely-available protocols, such as Transmission Control Protocol/Internet Protocol (TCP/IP), File Transfer Protocol (FTP), Universal Plug and Play (UPnP), Network File System (NFS), Common Internet File System (CIFS), Extensible Messaging and Presence Protocol (XMPP), AppleTalk, etc. The network(s) can include, for example, a local area network (LAN), a wide-area network (WAN), a virtual private network (VPN), the Internet, an intranet, an extranet, a public switched telephone network (PSTN), an infrared network, a wireless network, and any combination thereof.

In examples using a web server, the web server can run any of a variety of server or mid-tier applications, including HTTP servers, File Transfer Protocol (FTP) servers, Common Gateway Interface (CGI) servers, data servers, Java servers, business application servers, etc. The server(s) also can be capable of executing programs or scripts in response requests from user devices, such as by executing one or more Web applications that can be implemented as one or more scripts or programs written in any programming language, such as Java®, C, C# or C++, or any scripting language, such as Perl, Python, PHP, or TCL, as well as combinations thereof. The server(s) can also include database servers, including without limitation those commercially available from Oracle®, Microsoft®, Sybase®, IBM®, etc. The database servers can be relational or non-relational (e.g., “NoSQL”), distributed or non-distributed, etc.

Environments disclosed herein can include a variety of data stores and other memory and storage media as discussed above. These can reside in a variety of locations, such as on a storage medium local to (and/or resident in) one or more of the computers or remote from any or all of the computers across the network. In a particular set of examples, the information can reside in a storage-area network (SAN) familiar to those skilled in the art. Similarly, any necessary files for performing the functions attributed to the computers, servers, or other network devices can be stored locally and/or remotely, as appropriate. Where a system includes computerized devices, each such device can include hardware elements that can be electrically coupled via a bus, the elements including, for example, at least one central processing unit (CPU), at least one input device (e.g., a mouse, keyboard, controller, touch screen, or keypad), and/or at least one output device (e.g., a display device, printer, or speaker). Such a system can also include one or more storage devices, such as disk drives, optical storage devices, and solid-state storage devices such as random-access memory (RAM) or read-only memory (ROM), as well as removable media devices, memory cards, flash cards, etc.

Such devices also can include a computer-readable storage media reader, a communications device (e.g., a modem, a network card (wireless or wired), an infrared communication device, etc.), and working memory as described above. The computer-readable storage media reader can be connected with, or configured to receive, a computer-readable storage medium, representing remote, local, fixed, and/or removable storage devices as well as storage media for temporarily and/or more permanently containing, storing, transmitting, and retrieving computer-readable information. The system and various devices also typically will include a number of software applications, modules, services, or other elements located within at least one working memory device, including an operating system and application programs, such as a client application or web browser. It should be appreciated that alternate examples can have numerous variations from that described above. For example, customized hardware might also be used and/or particular elements might be implemented in hardware, software (including portable software, such as applets), or both. Further, connection to other computing devices such as network input/output devices can be employed.

Storage media and computer readable media for containing code, or portions of code, can include any appropriate media known or used in the art, including storage media and communication media, such as but not limited to volatile and non-volatile, removable and non-removable media implemented in any method or technology for storage and/or transmission of information such as computer readable instructions, data structures, program modules, or other data, including RAM, ROM, Electrically Erasable Programmable Read-Only Memory (EEPROM), flash memory or other memory technology, Compact Disc-Read Only Memory (CD-ROM), Digital Versatile Disk (DVD) or other optical storage, magnetic cassettes, magnetic tape, magnetic disk storage or other magnetic storage devices, or any other medium which can be used to store the desired information and which can be accessed by a system device. Based on the disclosure and teachings provided herein, a person of ordinary skill in the art will appreciate other ways and/or methods to implement the various examples.

In the preceding description, various examples are described. For purposes of explanation, specific configurations and details are set forth in order to provide a thorough understanding of the examples. However, it will also be apparent to one skilled in the art that the examples can be practiced without the specific details. Furthermore, well-known features can be omitted or simplified in order not to obscure the example being described.

Bracketed text and blocks with dashed borders (e.g., large dashes, small dashes, dot-dash, and dots) are used herein to illustrate optional aspects that add additional features to some examples. However, such notation should not be taken to mean that these are the only options or optional operations, and/or that blocks with solid borders are not optional in certain examples.

Reference numerals with suffix letters (e.g., 718A-718N) can be used to indicate that there can be one or multiple instances of the referenced entity in various examples, and when there are multiple instances, each does not need to be identical but may instead share some general traits or act in common ways. Further, the particular suffixes used are not meant to imply that a particular amount of the entity exists unless specifically indicated to the contrary. Thus, two entities using the same or different suffix letters might or might not have the same number of instances in various examples.

References to “one example,” “an example,” etc., indicate that the example described may include a particular feature, structure, or characteristic, but every example may not necessarily include the particular feature, structure, or characteristic. Moreover, such phrases are not necessarily referring to the same example. Further, when a particular feature, structure, or characteristic is described in connection with an example, it is submitted that it is within the knowledge of one skilled in the art to affect such feature, structure, or characteristic in connection with other examples whether or not explicitly described.

Moreover, in the various examples described above, unless specifically noted otherwise, disjunctive language such as the phrase “at least one of A, B, or C” is intended to be understood to mean either A, B, or C, or any combination thereof (e.g., A, B, and/or C). Similarly, language such as “at least one or more of A, B, and C” (or “one or more of A, B, and C”) is intended to be understood to mean A, B, or C, or any combination thereof (e.g., A, B, and/or C). As such, disjunctive language is not intended to, nor should it be understood to, imply that a given example requires at least one of A, at least one of B, and at least one of C to each be present.

As used herein, the term “based on” (or similar) is an open-ended term used to describe one or more factors that affect a determination or other action. It is to be understood that this term does not foreclose additional factors that may affect a determination or action. For example, a determination may be solely based on the factor(s) listed or based on the factor(s) and one or more additional factors. Thus, if an action A is “based on” B, it is to be understood that B is one factor that affects action A, but this does not foreclose the action from also being based on one or multiple other factors, such as factor C. However, in some instances, action A may be based entirely on B.

Unless otherwise explicitly stated, articles such as “a” or “an” should generally be interpreted to include one or multiple described items. Accordingly, phrases such as “a device configured to” or “a computing device” are intended to include one or multiple recited devices. Such one or more recited devices can be collectively configured to carry out the stated operations. For example, “a processor configured to carry out operations A, B, and C” can include a first processor configured to carry out operation A working in conjunction with a second processor configured to carry out operations B and C.

Further, the words “may” or “can” are used in a permissive sense (i.e., meaning having the potential to), rather than the mandatory sense (i.e., meaning must). The words “include,” “including,” and “includes” are used to indicate open-ended relationships and therefore mean including, but not limited to. Similarly, the words “have,” “having,” and “has” also indicate open-ended relationships, and thus mean having, but not limited to. The terms “first,” “second,” “third,” and so forth as used herein are used as labels for the nouns that they precede, and do not imply any type of ordering (e.g., spatial, temporal, logical, etc.) unless such an ordering is otherwise explicitly indicated. Similarly, the values of such numeric labels are generally not used to indicate a required amount of a particular noun in the claims recited herein, and thus a “fifth” element generally does not imply the existence of four other elements unless those elements are explicitly included in the claim or it is otherwise made abundantly clear that they exist.

The specification and drawings are, accordingly, to be regarded in an illustrative rather than a restrictive sense. It will, however, be evident that various modifications and changes can be made thereunto without departing from the broader scope of the disclosure as set forth in the claims.

What is claimed is:

1. A computer-implemented method comprising:
receiving, by an automated reasoning service of a cloud provider network, a request identifying: a policy managed by an identity and access management service of the cloud provider network, and a property expressing a desired condition of the policy;
invoking a first SMT solver system based on the policy and the property, wherein the first SMT solver system includes a modeler and a plurality of SMT solvers, wherein invoking the first SMT solver system causes the first SMT solver system to:
generate, by the modeler, a first-order logic formula based on the policy and the property, and
provide the first-order logic formula to the plurality of SMT solvers to obtain first results data indicating whether the first-order logic formula is satisfiable or unsatisfiable;
invoking a second SMT solver system based on the policy, the property, and the first results data;
obtaining second results data from the second SMT solver system; and
causing display of data indicating whether first results data differs from the second results data.

2. The computer-implemented method of claim 1, wherein invoking the first SMT solver system further causes the first SMT solver system to: obtain the first results data based on an earliest result received from an SMT solver of the plurality of SMT solvers, and terminate SMT solvers of the plurality of SMT solvers from which the earliest result was not obtained; and
wherein the second SMT solver system obtains results from two or more of the plurality of SMT solvers, and wherein the second results data includes the results from two or more of the plurality of SMT solvers.

3. The computer-implemented method of claim 1, wherein the second SMT solver system differs from the first SMT solver system based on at least one of: a different implementation of the modeler, or one or more different configurations of the modeler.

4. A computer-implemented method comprising:
receiving a request identifying a policy associated with one or more computing resources and a property expressing a desired condition of the policy;
invoking a first SMT solver system based on the policy and the property, wherein the first SMT solver system:
generates a formula based on the policy and the property, and
provides the formula to a plurality of SMT solvers to obtain first results data indicating whether the formula is satisfiable or unsatisfiable;
invoking a second SMT solver system based on the policy, the property, and the first result data;
obtaining second results data from the second SMT solver system; and
providing data indicating whether the first results data differs from the second results data to another component.

5. The computer-implemented method of claim 4, wherein invoking the first SMT solver system further causes the first SMT solver system to: obtain the first results data based on an earliest result received from an SMT solver of the plurality of SMT solvers, and terminate SMT solvers of the plurality of SMT solvers from which the earliest result was not obtained; and
wherein the second SMT solver system obtains results from two or more of the plurality of the plurality of SMT solvers, and wherein the second results data includes the results from two or more of the plurality of SMT solvers.

6. The computer-implemented method of claim 4, wherein the second SMT solver system differs from the first SMT solver system based on at least one of: a different implementation of a modeler used to generate the formula based on the policy and the property, or one or more different configurations of the modeler.

7. The computer-implemented method of claim 4, further comprising:
storing, by the first SMT solver system, the first results data in a storage resource accessible to the first SMT solver system and the second SMT solver system; and
obtaining, by the second SMT solver system, the first results data from the storage resource.

8. The computer-implemented method of claim 4, further comprising:
storing, by the first SMT solver system, a plurality of results data including the first results data in a storage resource accessible to the first SMT solver system and the second SMT solver system; and
wherein the second SMT solver system is invoked on a sampled subset of the plurality of results data stored in the storage resource.

9. The computer-implemented method of claim 4, wherein the second SMT solver system includes a second plurality of SMT solvers that is different from the first plurality of SMT solvers, and wherein the second plurality of SMT solvers is different from the first plurality of SMT solvers based on at least one of: the second plurality of SMT solvers includes an additional SMT solver compared to the first plurality of SMT solvers, the second plurality of SMT solvers includes fewer solvers compared to the first plurality of SMT solvers, or the second plurality of SMT solvers includes a different version of a solver in the first plurality of SMT solvers.

10. The computer-implemented method of claim 4, further comprising:
invoking a third SMT solver system based on the policy, the property, and the first result data;
obtaining third results data from the third SMT solver system;
comparing the third results data to the second results data; and
causing display of information indicating a difference between the third results data and the second results data.

11. The computer-implemented method of claim 4, further comprising generating an alert indicating the difference between the first results data and the second results data.

12. The computer-implemented method of claim 4, further comprising:
receiving input identifying a plurality of requests, wherein each of the plurality of requests identifies a respective policy and a respective condition; and
invoking the second SMT solver system on each request of the plurality of requests.

13. The computer-implemented method of claim 4, further comprising:
storing, by the first SMT solver system, first metrics related a first execution time of the first SMT solver system to obtain the first results data; and
storing, by the second SMT solver system, second metrics related to a second execution time of the second SMT solver system to obtain the second results data.

14. The computer-implemented method of claim 4, wherein the results data includes information identifying a version of the first SMT solver system and state information related to the first SMT solver system during invocation of the first SMT solver system.

15. A system comprising:
a first one or more electronic devices to implement an automated reasoning service in a multi-tenant provider network, wherein the automated reasoning service includes instructions that upon execution cause the automated reasoning service to:
receive a request identifying: a policy managed by an identity and access management service of the multi-tenant provider network, and a property expressing a desired condition of the policy;
invoke a first SMT solver system based on the policy and the property, wherein the first SMT solver system includes a modeler and a plurality of SMT solvers to obtain first results data;
invoke a second SMT solver system based on the policy, the property, and the first results data;
obtain second results data from the second SMT solver system; and
causing display of data indicating whether first results data differs from the second results data; and
a second one or more electronic devices to implement the first SMT solver system in the multi-tenant provider network, wherein the first SMT solver system includes instructions that upon execution cause the first SMT solver system to:
generate, by the modeler, a first-order logic formula based on the policy and the property, and
provide the first-order logic formula to the plurality of SMT solvers to obtain first results data indicating whether the first-order logic formula is satisfiable or unsatisfiable.

16. The system of claim 15, wherein invoking the first SMT solver system further causes the first SMT solver system to: obtain the first results data based on an earliest result received from an SMT solver of the plurality of SMT solvers, and terminate SMT solvers of the plurality of SMT solvers from which the earliest result was not obtained; and
wherein the second SMT solver system obtains results from two or more of the plurality of the plurality of SMT solvers, and wherein the second results data includes the results from two or more of the plurality of SMT solvers.

17. The system of claim 15, wherein the second SMT solver system differs from the first SMT solver system based on at least one of: a different implementation of the modeler, or one or more different configurations of the modeler.

18. The system of claim 15, wherein the instructions, upon execution by the automated reasoning service, further cause the automated reasoning service to:
store, by the first SMT solver system, the first results data in a queue provided by a service of a cloud provider network; and
obtain, by the second SMT solver system, the first results data from the queue.

19. The system of claim 15, wherein the instructions, upon execution by the automated reasoning service, further cause the automated reasoning service to:
store, by the first SMT solver system, a plurality of results data including the first results data in a storage resource provided by a cloud provider network; and
wherein the second SMT solver system is invoked on a sampled subset of the plurality of results data.

20. The system of claim 15, wherein the second SMT solver system includes a second plurality of SMT solvers that is different from the first plurality of SMT solvers.
